(19) United States
(12) Patent Application Publication
(10) Pub. No.: US 2007/0084860 A1
(43) Pub. Date: Apr. 19, 2007

(54) Microwave susceptor incorporating heat stabilized polyester

(76) Inventor: William R. Corcoran JR., Kennett Squar, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/511,828

(22) Filed: Aug. 29, 2006

Related U.S. Application Data
(60) Provisional application No. 60/712,220, filed on Aug. 29, 2005.

(51) Int. Cl. H05B 6/80

(52) U.S. Cl. 219/730

(57) ABSTRACT

This invention relates to microwave susceptors useful in microwave cooking. More specifically, this invention relates to a process for microwave cooking using microwave susceptors comprising an metalized heat-stabilized polyester substrate. Further, this invention relates to a process for microwave cooking, wherein the optical density of the metalized film coated or deposited on the heat-stabilized polyester substrate is in the range of greater than 0.25 to about 0.45.

This application claims the benefit of U.S. Provisional Application 60/712,224, which was filed 29 Aug. 2005 and is incorporated in its entirety as a part hereof for all purposes.

### TECHNICAL FIELD

The present invention relates to the field of microwave heating, and in particular to the use of so-called microwave susceptors for providing localized thermal heating. Most particularly, the present invention relates to a technology for providing thermal heating while avoiding overheating. The inventions provided herein are useful, for example, for the purpose of heating a human food item, and in particular for browning or crisping a food item without burning it.

### BACKGROUND

Cooking food by heating it in a microwave oven differs from cooking food in a conventional oven. In a conventional oven, heat energy is applied to the exterior surface of food, and the heat energy moves inward until the food is cooked. Food cooked in a conventional oven is thus often as hot or hotter on the exterior surface thereof as it is in the interior, such as in the center.

Cooking food by heating it in a microwave oven, by contrast, involves irradiating the food with microwave radiation. Microwave energy is absorbed by the food, and microwaves characteristically penetrate far deeper into the food than does conventional heat energy. The air temperature in a microwave oven may thus be relatively low, and it is not uncommon for food cooked in a microwave oven to be cooler on the exterior surface thereof than it is in the interior, such as in the center.

Making the exterior surface of food cooked in a microwave oven brown and/or crisp thus represents a special challenge. The exterior surface of the food must be heated to a sufficient degree to drive away moisture and cook that portion of the food, but heating the food to the extent necessary to reach the desired temperature on the exterior may result in raising the temperature of the interior of the food to a level at which it is burned.

So-called microwave susceptors have been developed to facilitate the directional and locational delivery of heat in a microwave oven. A microwave susceptor, as used in both consumer and industrial applications, is a material that absorbs microwave energy, converts the absorbed energy to heat energy, and thereby heats surrounding media. When it is desired to use a microwave susceptor to heat a food item, the food item is typically disposed in heatable proximity to the susceptor such that, upon microwave irradiation, the food item will be heated by both direct absorption of microwave radiation and by conduction and/or convection heating from the susceptor.

Whatever object or portion of an object is placed closest to a susceptor will experience a greater rise in temperature from being heated in a microwave oven than those objects or portions of objects that are more distant from a susceptor. A susceptor is thus well suited to the job of browning and/or crisping the exterior surface of a food item. A susceptor, or susceptor structure, can be placed in heatable proximity to the exterior surface of a food item for the purpose of delivering heat to only or primarily the desired locations to a much greater extent than would occur in the absence of the susceptor. When a susceptor or a susceptor structure is arranged about the exterior of a food item that needs to be browned and/or crisped, the heat concentrated on that location is available to do the desired job of cooking without a need to heat the whole food item to such an extent that other portions, particularly the interior or center, will be burned.

Microwave susceptors may be prepared from materials that include a thin metal layer, typically aluminum, deposited on a substrate film or sheet, typically poly(ethylene terephthalate) (PET). The metallized film or sheet may be bonded, for support, to a support member such as a sheet of paperboard or corrugated paper. U.S. Pat. No. 4,851,632 and U.S. Pat. No. 5,003,142 disclose using a low-shrinkage, so-called heat-stabilized, polyester as a substrate material. Further disclosed therein is that “[a] preferred susceptor material is vacuum metallized aluminum, which will preferably be present in sufficient amounts to impart an optical density of about 0.1 to about 0.35, preferably 0.16 to about 0.22, to the film.”

U.S. Pat. No. 5,177,332 discloses aluminized PET structures that have multiple-layer constructions, for example, multiple PET-based layers laminated together. Heat-stabilized PET was used to reduce shrinkage in a multiple-layer laminate. Susceptor substrates, based on conventional PET, had optical densities such as 0.13, 016-0.19, and 0.23-0.28.

The degree of cooking, browning and crisping of human food items, such as raw, uncooked dough, that can currently be achieved is still limited by the temperature limitations of the microwave oven systems in common commercial use. It is desired to expand the range of browning and crisping capabilities of microwave susceptors by developing microwave susceptors that are capable of directing heat to only the locations where it is needed to perform a demanding cooking job such as browning and crisping dough. Many putative solutions to the problem exhibit a tendency to impart excessive heat to a whole food item, resulting in run-away heating, charring, or even burning, the whole food item rather than browning only certain areas. In some instances, an entire microwaveable package will ignite. The technological challenge is not to simply expose the whole food item to a higher temperature, but to direct an appropriately high temperature to a selected area of the food item so that those portions of the food item can be cooked as desired without over cooking or burning the remainder of the food item.

### SUMMARY

In one embodiment, this invention provides a microwave susceptor that includes a planar substrate having on one side thereof a metal coating, wherein the substrate comprises heat-stabilized polyester, and the susceptor has an optical density in the range from greater than 0.25 to about 0.45.

In another embodiment, this invention provides a method of cooking a human food item by (a) providing a microwave susceptor that comprises a planar substrate having on one side thereof a metal coating, wherein the substrate comprises heat-stabilized polyester, and the susceptor has an optical density in the range from greater than 0.25 to about 0.45; (b) placing the food item, or a portion thereof, in heatable proximity to the microwave susceptor; and (c) subjecting the food item and susceptor to microwave radiation.

In a further embodiment, this invention provides a multi-layer structure comprising as a layer therein a microwave susceptor that comprises a planar substrate having on one side thereof a metal coating, wherein the substrate comprises heat-stabilized polyester, and the susceptor has an optical density in the range from greater than 0.25 to about 0.45.

In yet another embodiment, this invention provides a package that protects a human food item from contamination, wherein the package encloses or is contacted with a microwave susceptor that comprises a planar substrate having on one side thereof a metal coating, wherein the substrate comprises heat-stabilized polyester, and the susceptor has an optical density in the range from greater than 0.25 to about 0.45.

In yet another embodiment, this invention provides a method of making a microwave susceptor comprising providing a susceptor that comprises a planar substrate having on one side thereof a metal coating, wherein the substrate comprises heat-stabilized polyester, and the susceptor has an optical density in the range from greater than 0.25 to about 0.45; wherein the susceptor is fabricated as, is enclosed in, or is contacted with, a package that protects human food from contamination.

### BRIEF DESCRIPTION OF THE DRAWINGS

FIG. 1 depicts the time dependence of microwave susceptor heating.

FIG. 2 depicts one embodiment of a food package according to this invention.

FIG. 3 depicts a polynomial least squares fit for the percent browning vs. optical density data of the examples.

FIG. 4 shows pizza browning results for various examples.

### DETAILED DESCRIPTION

It has been a long-sought goal in the microwave cooking industry to improve the freshness of microwave cooked products such as pies and pizzas by supplying frozen, uncooked product to the consumer for cooking in the home microwave oven. Because of materials limitations in current commercial practice, currently available products are partially cooked before freezing and simply reheated before serving. Microwave susceptors in current commercial use are adequate for providing a final crisping and browning of a food item that has previously been at least partially cooked. However, they have been found to exhibit insufficient durability for cooking and browning raw, uncooked dough.

Dough in this sense refers to a mixture of a dry component such as flour and/or other milled grain with a wet component that is stiff enough to knead or roll. The dough is then shaped as appropriate to provide the body or a portion thereof of a variety of baked goods. Raw dough is dough that has not previously cooked.

The desired microwave susceptor will exhibit superior high temperature durability without excessive heating which can cause charring and burning. In particular, the present invention provides unexpectedly better results in terms of browning and crisping of baked goods, especially pizza crusts, over conventional technology.

This invention relates to a microwave susceptor useful in microwave cooking. More specifically, this invention relates to a process for microwave cooking using a microwave susceptor comprising an metalized heat-stabilized polyester film or sheet with an optical density in a range from greater than 0.25 to about 0.45. At optical densities below 0.25, insufficient browning occurs. As optical density is increased from 0.25 to 0.45 the degree of browning is observed to increase, especially at optical densities in the range of greater than 0.35 to about 0.45. At optical density greater than about 0.45 the degree of browning begins to decrease.

While not wishing to be bound by any theory of operation of the invention, it is believed that at optical densities greater than about 0.45, the aluminum coating begins to reflect the microwave radiation rather than absorb and transmit it. Thus the amount of energy actually being transmitted to the food is believed to decrease at optical densities greater than about 0.45.

In the typical practice of the invention, as illustrated in FIG. 1, the temperature of the microwave susceptor rises rapidly in about the first thirty seconds of exposure to microwave radiation, reaches a plateau, and stays constant in a range of plus or minus 5° C. for the next several minutes, wherein the bulk of the cooking occurs. In FIG. 1, the y-axis represents the temperature as determined by an infrared thermometer, and the x-axis the time of exposure to microwave radiation. FIG. 1 depicts the performance of a Melinex® ST-505 heat stabilized polyester film coated with aluminum to 0.30 OD. The test sample was exposed to 100 watts of microwave radiation.

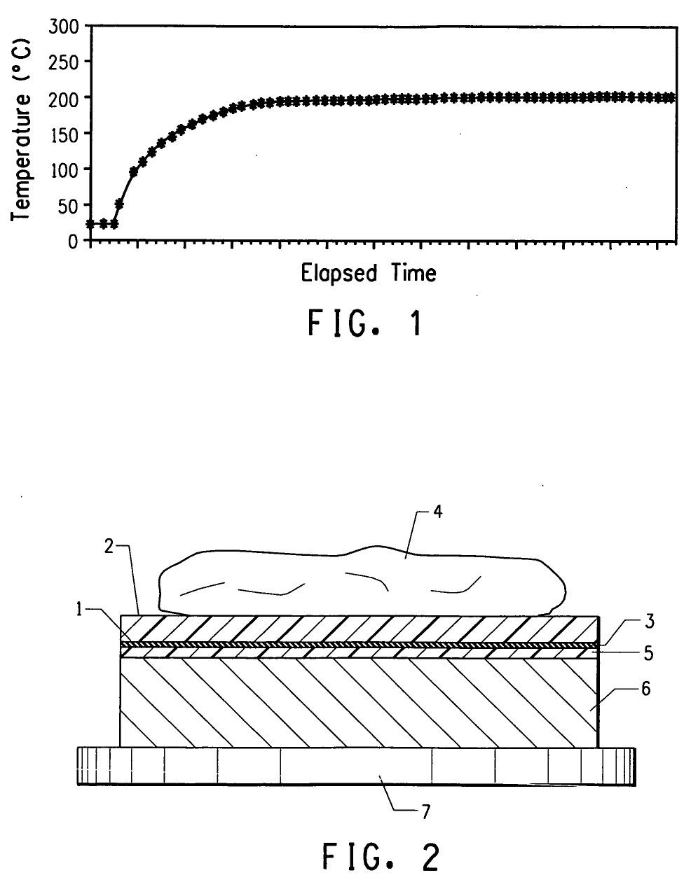

In accord with the present invention, as shown in FIG. 2, the microwave susceptor comprises a substrate with a first side, 1, and a second side, 2, and metal coating or layer, such as an aluminized coating or layer, 3, disposed on the first side of the substrate. In a preferred embodiment of the invention, shown in FIG. 2, a food item, 4, is disposed such that it is in contact with the second side of the substrate. In another preferred embodiment, the microwave susceptor further comprises a support layer, 5, wherein the support layer is in contact with the second side of the substrate.

In a further embodiment, also shown in FIG. 2, the metalized heat stabilized polyester sheet or film is incorporated into a food package which is disposed after opening in a microwave oven for cooking the food. In typical use, there will be a platform or stage, 6, typically of cardboard, shaped to support the entire susceptor and food parts of the package. The entire structure herein above described is designed to rest on the floor of a microwave oven, or upon a turntable therein 7.

According to the present invention, the substrate of the susceptor is fabricated from a heat-stabilized PET. Heat-stabilized PET is made from an ordinary grade of PET film by a stabilization process involving a series of heat treatment and relaxation steps to give good molecular orientation, as is known in the art. A heat stabilization process for PET is described in U.S. Pat. No. 4,851,632, which is incorporated in its entirety as a part hereof for all purposes. Heat-stabilized PET is commercially available from numerous sources including Dupont-Teijin Films.

In accord with the present invention, a metal such as aluminum is deposited on the heat-stabilized PET substrate through vacuum deposition, sputtering, or another similar method. Vacuum deposition, a widely practiced method in the art, is a preferred method of depositing aluminum on the substrate.

In a preferred embodiment, a support layer, typically a paper or a paperboard is in contact with the metal layer. In one embodiment, the contact between the metal layer and the support layer is accomplished with an intermediary adhesive layer.

The support layer may be prepared from materials such as cellulosic paper, and papers formed from polyaramids polymers, such as from fibrils of poly(metaphenylene isophthalamide), fibrils of poly(paraphenylene terephthalamide), and mixtures thereof. Because polyaramid papers are highly heat-resistant, they are safer to use compared to cellulosic paper in high-temperature microwave susceptor applications such as that of the instant invention.

In an alternative embodiment of the invention, however, the microwave susceptor does not have the support layer.

The metal layer is microwave interactive. A component is microwave-interactive when it is prepared from a material that is electrically conductive, and/or when it experiences heating when subjected to microwave irradiation by converting absorbed microwave energy to heat. The metal layer thus undergoes heating upon exposure to microwave radiation as a result of electrical resistance heating caused by surface currents induced therein. According to the present invention, the microwave susceptor herein described is subjected to microwave radiation, the metal layer is thereby heated, and the heat is transferred to the food item placed in heatable proximity to the microwave susceptor. In a very short time, i.e., in about 30 seconds, the rate of increase with time of temperature of the microwave susceptor decreases significantly and a plateau is reached, as shown in FIG. 1.

In a typical embodiment hereof, the food item placed in a heatable proximity to the microwave susceptor is heated both by direct absorption of microwave energy by the food item and by heat transfer from the heated susceptor. By “heatable proximity” is meant that the item to be heated is placed in direct or indirect contact with the microwave susceptor, or in partial direct or indirect contact with the microwave susceptor, at a close enough distance that the heated transmitted by the susceptor is received and absorbed by the food item.

Preferably, the heat-stabilized polyester substrate is coated with a thin layer of metal such as aluminum by vacuum deposition techniques. In this embodiment, the metal layer can be a substantially continuous electrically conductive material which is present in sufficient amounts to impart an optical density of greater than 0.25 to about 0.45, preferably greater than 0.35 to about 0.45. Methods other than vacuum deposition may also be used if they provide a substantially continuous layer of the desired thickness.

The thickness of the metal layer in the microwave susceptor, as applied to a sheet of heat-stabilized polyester, is indicated by the optical density of the microwave susceptor. Optical density is defined as log₁₀ [l/T] where T is the transmittance of visible light (400-700 nm wavelength) by the microwave susceptor, i.e. by the sheet of polyester that contains the metal coating on one side thereof. As the thickness of the metal coating increases, the amount of light transmitted by the susceptor will decrease. Measurement of transmittance may be performed, for example, by use of a spectroradiometer, such as a OL-750 spectroradiometer from Optronic Laboratories, Orlando, Fla.

A microwave susceptor of this invention can be formed as a film or a sheet. It can also have a configuration of a pouch or a package that can contain the food item to be heated. It can also be a wrappable film or a sheet that wraps the food item to be heated, or other configurations that place the food item in heatable proximity to the microwave susceptor.

In one embodiment, the microwave susceptor of the present invention is used to heat food items containing dough such as raw dough. Dough-containing food items that can be heated include pizza, cookies, pies, bread, and other baking food items. Pizza crust in particular is advantageously browned and crisped according to the method of the present invention.

An object to be heated may be disposed in heatable proximity to a microwave susceptor of this invention, in which spatial relation heat is transferred from the susceptor to the object to be heated. Upon being subjected to microwave irradiation, the microwave susceptor will undergo heating, which in turn will cause the heatable object to undergo heating, particularly at the surface thereof. The heatable object may be any non-electrically conductive material, which may or may not be transparent to microwave radiation. Thus, a heatable object may be heated both by the direct absorption of microwave radiation, and by the conductive heating of the microwave susceptor.

A further embodiment of this invention is thus a method of heating an object by placing the object in heatable proximity to a microwave susceptor of this invention, and exposing the object and the susceptor to microwave radiation. In a preferred embodiment, the object to be heated is a food item such as a pizza or raw pizza dough. The food item may be placed directly in contact with the susceptor, or may be placed in a separate container which is placed in contact with the susceptor. A food item of particular interest is a pizza, which requires excellent browning and crisping without charring. The food item, and a susceptor hereof, may be contained in a housing, enclosure or package for ease of storage, shipping and protection from contamination. Thus, according to a method of the invention, the combination of a food item disposed proximate to a susceptor hereof may be placed in a package for the purpose of being heated. The package may be provided with an opening to the interior during heating in order to allow venting of hot gases.

A further embodiment of this invention is thus an article comprising a combination of an object and a microwave susceptor of this invention, wherein the object is placed in heatable proximity to the susceptor. In a preferred embodiment, the object to be heated is a food item such as a pizza. FIG. 2 shows such a combination-type article.

In other embodiments, a microwave susceptor hereof may be incorporated into a layered structure. In addition to the susceptor, the layered structure may be fabricated from other layers made from materials including polymeric films, both semicrystalline thermoplastic and thermoset, microwave transparent plastic sheet materials, paper or paperboard, woven or non-woven fabrics, or a multilayered laminated structure having a dielectric backing substrate that is transparent to microwave energy. Suitable polymeric films include polyesters, polyetherketones, polyimides, polyolefins and copolymers thereof, polyvinylaromatics, polycarbonates, acrylate polymers, and the like; and to a somewhat lesser extent polyamides and polyolefins and copolymers thereof. Suitable paper and paperboard includes cellulosic paper, and papers formed from fibrils of poly(m-phenyleneisophthalamide), poly(p-phenyleneterephthalamide), and mixtures thereof. Exemplary is 15 to 50-pound grease proof kraft paper. A layer in a layered structure or multi-layer laminate will typically be about 25 to about 50 micrometers thick, and will be stable up to about 250°-300° C. The layered structure may be used to protect human food, such as a frozen pizza, from contamination.

When the susceptor hereof is a separate sheet or film, the polyester sheet or film substrate may, for example, be fabricated as free-standing film by film casting, molding, profile extrusion, pultrusion and the like. Lamination of layers may be performed by any convenient means such as thermal calendaring or adhesive bonding.

In another embodiment, an article may be prepared by enclosing a microwave susceptor hereof in a package prepared from materials that are suitable for use to protect human food from contamination. In a further embodiment, an article may be fabricated in which a microwave susceptor hereof is contacted with a package prepared from materials that are suitable for use to protect human food from contamination. Such package may be fabricated from a material that is FDA approved and/or is not microwave interactive.

In a further embodiment, this invention also provides a method of making a microwave susceptor by fabricating the susceptor from a metalized heat-stabilized polyester sheet or film. The method may further involve incorporating the susceptor into a layered structure. The layered structure may in turn be fabricated from substrate-type material that is not microwave interactive, and the layered structure may be fabricated into a package that protects human food from contamination. Alternatively, a susceptor as provided herein may be enclosed in, or contacted with, a package that protects human food from contamination.

In a further embodiment, this invention also provides method of heating an object by placing the object is heatable proximity to a microwave susceptor as provided herein, and subjecting the object and the microwave susceptor to microwave radiation.

The range of circumstances for which the susceptor of this invention, and articles prepared therefrom, are useful is further extended by additionally preparing susceptors having ODs designed particularly for microwave ovens of varying power, which may vary, for example, within at least the range of about 700-1200 Watts.

The present invention is further described in the following specific embodiments, which are illustrative but not limiting.

### EXAMPLES

Microwavable pizzas (Kraft's DiGiorno Microwave Four Cheese Pizza, 280 g) were used in all cooking experiments.

Browning, and browning uniformity, profiles of the pizza bottom crust were measured according to the general procedure described in Papadakis, “A Versatile and Inexpensive Technique for Measuring Color of Foods”, Food Technology, 54 (12) pp. 48-51 (2000). Accordingly, a lighting system was set up, and a digital camera (Nikon model D1) was used to take images of the bottom crust. An image and graphics software program was used to convert color parameters to the L-A-B color model, the preferred color model for food research. The percent browned area was defined as percent of pixels with a lightness L value of less than 153 (on a scale of 0 to 255). To obtain the browning color profile as a function of the radius of the pizza, the image of the bottom crust was divided into multiple concentric rings, and the mean L value or the percent browned area was calculated for each section. To distinguish browning from blackening and charring, the calculated results were confirmed by visual inspection.

Oven 1 was the Panasonic Model NN5760WA with a Wattage capacity of 1300 W. Oven 2 was Sanyo Model EM-Z2000S with a Wattage capacity of 1000 W. Oven 3 was Kenmore Model 721.62349202 with a Wattage capacity of 1200 W.

### Example 1

A 75 micrometer (3 mil) thick heat-stabilized polyester film, Melinex® ST-505 from DuPont Teijin Films, was metallized with aluminum. The aluminum layer was applied by vacuum deposition to two optical densities, as shown in Table 1. The metallized film was then laminated to paper board using type BR-4736 water soluble adhesive from Basic Adhesives. The lamination was conducted at room temperature at 1.6 m/min (5.2 ft/min) using a calendar roll at a roll pressure of 227 kg (500 lb)

Susceptor samples so prepared were used to cook the pizzas, according to the directions on the box. Results, presented as the percent (%) browning are shown in Table 1 below.

### Example 2

A 50 micrometer (2 mil) heat-stabilized polyester film, Melinex® ST-507 from DuPont Teijin Films, was metallized with aluminum. The aluminum layer was applied by vacuum deposition to two optical densities as shown in Table 1, samples identified as 2-1 and 2-2. The metallized film was laminated to paper board using the procedure of Example 1, and the resultant structures were used in the cooking experiments as described in Example 1. The results are shown in Table 1 below.

### Example 3

A 25 micrometer (1 mil) polyester film, Mylar® 800 from DuPont Teijin Films, was heat treated, by passing it through a 200° C. oven at low tension. An aluminum layer was applied by vacuum deposition to two optical densities as shown in Table 1, with samples identified as 3-1 and 3-2. The metallized film was laminated to paper board using the procedure of Example 1, and the resultant structures were used in the cooking experiments as described in Example 1. The results are shown in Table 1 below.

### Example 4

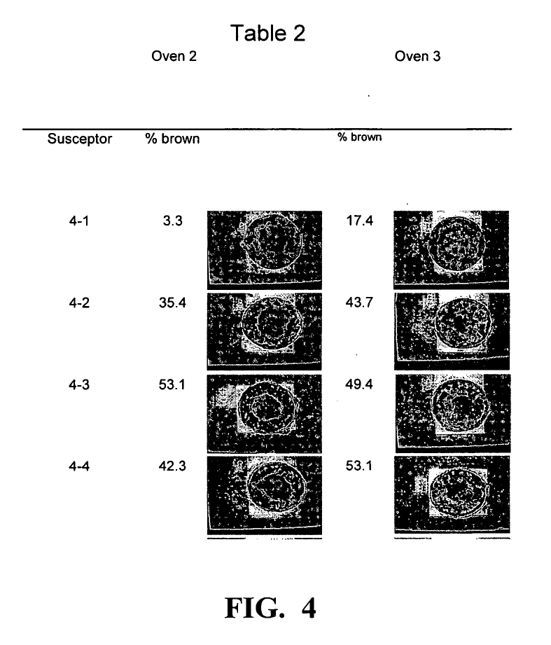

An aluminum layer was applied in a continuous process to rolls of Melinex® ST-507 heat-stabilized polyester film, 75 micrometers in thickness (0.003″), available from DuPont-Teijin Films. The rate of deposition was adjusted to produce films with five different optical densities, as shown in Table 1. Samples were identified as 4-1, 4-2, 4-3, 4-4, and 4-5. A portion of each metallized film was laminated to paper board using the procedure of Example 1, and the resultant structures used in the cooking experiments as described in Example 1. The results are shown in Table 1 below. Actual pizza browning results are shown in FIG. 4.

### Example 5

A 92 gauge (1 mil) heat-stabilized polyester film, Mylar® HS-2 from DuPont Teijin Films, was metallized with aluminum. The aluminum layer was applied by vacuum deposition to two optical densities as shown in Table 1 with samples identified as 5-1 and 5-2. The metallized film was also laminated to paper board utilizing the procedure of Example 1, and the resultant structures used in the cooking experiments as described in Example 1. The results are shown in Table 1 below.

### Examples 1-5

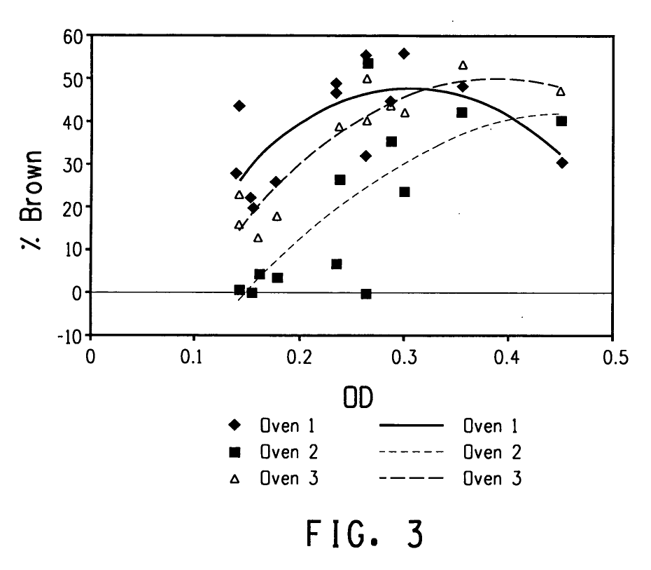

The percent browning in each test oven is plotted against the OD of the all the test specimens, in FIG. 3. The solid lines in the figure correspond to a polynomial least squares best fit of the data. Although they are referred to herein as examples, samples 1-1, 2-1, 3-1, 3-2, 4-1, 5-1 and 5-2 involve the use of susceptors in which the aluminum layer was applied at a thickness that gave the susceptor an optical density of less than 0.25. The experimental runs using those samples thus do not illustrate the invention, but rather are presented as comparisons to show that a desirable range of optical density in this type of susceptor exists above 0.25 up to about 0.45 OD, particularly in the range of above 0.35 to about 0.45 OD.

TABLE 1

| | | | Browning (%) | | |
|---|---|---|---|---|---|
| Example | | | OVEN | OVEN | OVEN |
| No. | Film Type | OD | 1 | 2 | 3 |
| 1-1 | Melinex ® ST-505 3 mil | 0.16 | 20.1 | 3.37 | 12.6 |
| 1-2 | Melinex ® ST-505 3 mil | 0.30 | 56.2 | 24.7 | 42.4 |
| 2-1 | Melinex ® ST-507 2 mil | 0.156 | 22.4 | N/A | 19.3 |
| 2-2 | Melinex ® ST-507 2 mil | 0.268 | 55.4 | N/A | 40.1 |
| 3-1 | Heat Treated Mylar ® | 0.142 | 43.1 | 0.27 | 16.2 |
| | 800 1 mil | | | | |
| 3-2 | Heat Treated Mylar ® | 0.234 | 48.3 | 26.4 | 38.6 |
| | 8001 mil | | | | |
| 4-1 | Melinex ® ST-507 3 mil | 0.18 | 25.9 | 3.3 | 17.4 |
| 4-2 | Melinex ® ST-507 3 mil | 0.29 | 44.6 | 35.4 | 43.7 |
| 4-3 | Melinex ® ST-507 3 mil | 0.27 | 31.9 | 53.1 | 49.4 |
| 4-4 | Melinex ® ST-507 3 mil | 0.36 | 48.7 | 42.3 | 53.1 |
| 4-5 | Melinex ® ST-507 3 mil | 0.45 | 31.1 | 40.2 | 45.7 |
| 5-1 | Mylar ® HS-2 1 mil | 0.140 | 27.6 | 0.55 | 22.5 |
| 5-2 | Mylar ® HS-2 1 mil | 0.235 | 46.3 | 7.25 | 36.6 |

Where a composition, article or method of this invention is stated or described as comprising, including, containing, having, being composed of or being constituted by certain components or features, it is to be understood, unless the statement or description explicitly provides to the contrary, that one or more components or features in addition to those explicitly stated or described may be present in the composition, article or method. In an alternative embodiment, however, the composition, article or method of this invention may be stated or described as consisting essentially of certain components or features, in which embodiment components or features that would materially alter the principle of operation or the distinguishing characteristics of the composition, article or method are not present therein. In a further alternative embodiment, the composition, article or method of this invention may be stated or described as consisting of certain components or features, in which embodiment components or features other than those stated or described are not present therein.

Where the indefinite article “a” or “an” is used with respect to a statement or description of the presence of a component or feature in a composition, article or method of this invention, it is to be understood, unless the statement or description explicitly provides to the contrary, that the use of such indefinite article does not limit the presence of the component or feature in the composition, article or method to one in number. The words “include”, “includes” and “including”, when used herein, are to be read and interpreted as if they were followed by the phrase “without limitation” if in fact that is not the case.

What is claimed is:

1. A method of cooking a food item comprising (a) providing a microwave susceptor that comprises a planar substrate having on one side thereof a metal coating, wherein the substrate comprises heat-stabilized polyester, and the susceptor has an optical density in the range from greater than 0.25 to about 0.45; (b) placing the food item, or a portion thereof, in heatable proximity to the microwave susceptor; and (c) subjecting the food item and susceptor to microwave radiation.

2. A method according to claim 1 wherein the food item is raw dough.

3. A method according to claim 1 wherein the optical density of the susceptor is in the range of greater than 0.35 to about 0.45.

4. A multi-layer structure comprising as a layer therein a microwave susceptor that comprises a planar substrate having on one side thereof a metal coating, wherein the substrate comprises heat-stabilized polyester, and the susceptor has an optical density in the range from greater than 0.25 to about 0.45.

5. A multi-layer structure according to claim 4 wherein the structure protects human food from contamination.

6. A multi-layer structure according to claim 4 wherein the human food comprises raw dough.

7. A multi-layer structure according to claim 4 wherein the optical density of the susceptor is in the range of greater than 0.35 to about 0.45.

8. A package that protects a human food item from contamination, wherein the package encloses or is contacted with a microwave susceptor that comprises a planar substrate having on one side thereof a metal coating, wherein the substrate comprises heat-stabilized polyester, and the susceptor has an optical density in the range from greater than 0.25 to about 0.45.

9. A package according to claim 8 that encloses the human food item

10. A package according to claim 8 wherein the food item is raw dough.

11. A package according to claim 8 wherein the optical density of the susceptor is in the range of greater than 0.35 to about 0.45.

12. A method of making a microwave susceptor comprising providing a susceptor that comprises a planar substrate having on one side thereof a metal coating, wherein the substrate comprises heat-stabilized polyester, and the susceptor has an optical density in the range from greater than 0.25 to about 0.45; wherein the susceptor is fabricated as, is enclosed in, or is contacted with, a package that protects human food from contamination.

13. A method according to claim 12 wherein the food item is raw dough.

14. A method according to claim 12 wherein the optical density of the susceptor is in the range of greater than 0.35 to about 0.45.
